(19) United States
(12) Patent Application Publication
(10) Pub. No.: US 2018/0216818 A1
(43) Pub. Date: Aug. 2, 2018

(54) ASH TREATMENT AND REINJECTION SYSTEM

(71) Applicant: Detroit Stoker Company, Monroe, MI (US)

(72) Inventors: Thomas A. GIAIER, Canton, MI (US); Daniel Donald HILL, JR., Canton, MI (US); Jacob Mitchell MILLER, Maumee, OH (US)

(21) Appl. No.: 15/420,088

(22) Filed: Jan. 30, 2017

(51) Int. Cl. F23J 15/02; B01D 45/08; B01D 45/12; F23G 5/033

(52) U.S. Cl. CPC F23J 15/022; B01D 45/08; F23J 2900/01001; F23G 5/033; F23J 2217/00; B01D 45/12

(57) ABSTRACT

A method and apparatus are provided for treating exhaust from a solid fuel combustion system such as a furnace or boiler and includes combusting a material in the combustion chamber and separating fly ash and char from a flue gas stream. The separated fly ash and char mixture is then separated further by separating smaller ash particles from larger char particles. The larger char particles are then reduced in size by a reducing device such as a grinder or crusher. Char particles that have been reduced in size by the grinder or crusher are then reinjected into the combustion chamber for re-burning.

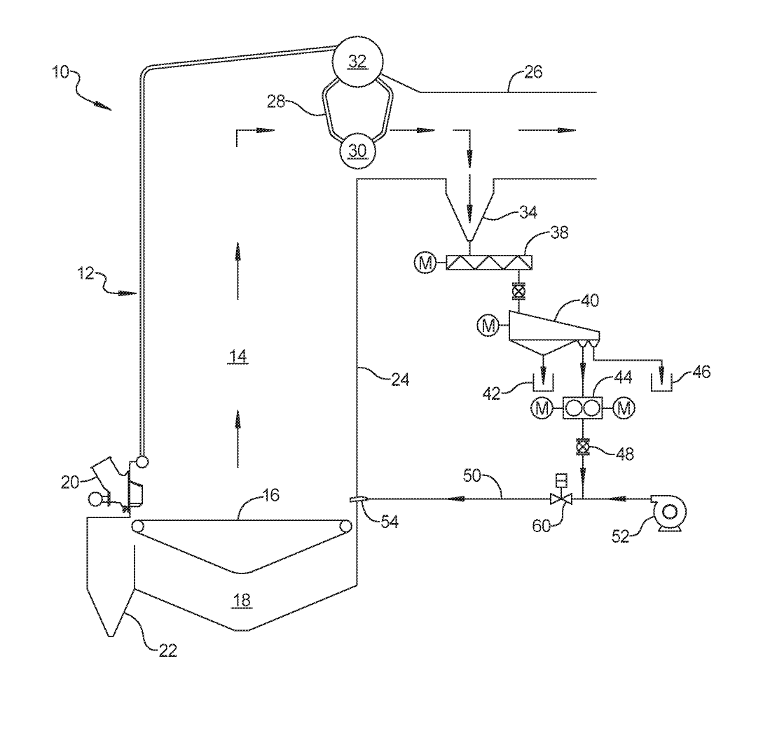

### FIELD

The present disclosure relates to an ash treatment and reinjection system for furnaces and boilers.

### BACKGROUND AND SUMMARY

This section provides background information related to the present disclosure which is not necessarily prior art.

Furnaces and boilers are commonly used in the combustion of solid fuels. The combustion process of solid fuels can create a mixture of ash and char material that is entrained in the combustion gases and passes through the combustion chamber to the flue. Known filtration systems have been utilized for filtering out the ash and char material for reducing the amount of ash and char released into the surrounding environment. The filtered out ash and char mixture is then properly disposed of.

### SUMMARY

This section provides a general summary of the disclosure, and is not a comprehensive disclosure of its full scope or all of its features.

According to an aspect of the present disclosure, a method of treating exhaust from a solid fuel fired furnace or boiler comprises combusting a material, such as wood waste, in the furnace or boiler and separating fly ash and char mixture from a flue gas stream. The separated fly ash and char mixture is then separated further by separating smaller ash particles from larger char particles. The larger char particles are then reduced in size by a reducing device such as a grinder or crusher. Char particles that have been reduced in size by the grinder or crusher are then reinjected into the furnace or boiler for re-burning.

According to a further aspect of the present disclosure, a solid fuel firing system is provided for combusting solid fuel and includes a furnace or boiler into which the solid fuel is introduced. A first separation system is provided for separating the fly ash and char mixture from a flue gas stream. A second separating system is provided for separating small ash particles from larger char particles. A reducing device is provided for reducing the size of the larger char particles into smaller particles. A blower system is then utilized for re-injecting the reduced size char particles into the furnace or boiler.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The FIGURE is a schematic view of a solid fuel combustion system employing an ash treatment and reinjection system according to the principles of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With reference to the accompanying FIGURE, the present disclosure provides a solid fuel combustion system 10 that can be in the form of a boiler or furnace 12 having a combustion chamber 14. A floor of the combustion chamber 14 can be provided with a grate 16 or other fluidized bed having an air plenum 18 disposed below the grate 16. A fuel feeding device 20 is provided for feeding fuel onto the grate 16 and an ash pit 22 is provided for receiving the bottom ash from the grate 16. The combustion chamber 14 includes sidewalls 24 that connect to a flue duct 26 that carries the combustion gases and fly ash away from the boiler or furnace 12. The furnace or boiler 12 can be provided with boiler tubes 28 that communicate with a water drum 30 and a steam drum 32, as is known in the art.

The flue duct 26 can include a gas stream hopper 34 that collects fly ash and char particles from the combustion gases. A filtration system including baffles, relying-on gravity, or centrifugal collectors can be provided for assisting in the separation of the fly ash and char particles into the hopper 34. The fly ash and char particles collected in the hopper 34 can be fed by a feed screw or other feed device 38 to separating equipment 40 that separates small particle ash into an ash hopper 42. The separating equipment further separates desired sized char particles for delivering them to reducing equipment 44 such as a crusher or grinder. The reducing equipment 44 reduces the size of the char particles to a desired size. It is anticipated that additional larger particles which are too large for introduction into the reducing equipment 44 may be further separated out and delivered to a large particle hopper 46 for processing or disposal.

By way of example, the reducing equipment 44 can include a pair of opposed rollers that crush or grind the char particles to a desired smaller size. A valve 48 can be provided for controlling the delivery of the crushed char particles from the reducing equipment 44 to a reinjection line 50 that can be provided with a blower 52 for reinjecting the crushed char particles into the combustion chamber 14 via injector nozzle 54. The blower 52 can be connected to a supply of atmospheric air or preferably flue gas which is oxygen depleted in order to reduce the introduction of oxygen into the combustion chamber 14.

An additional valve 48 can be utilized for controlling the delivery of fed ash particles from the feed device 38 to the separating equipment 40. An additional metering valve 60 can be utilized in the reinjection line 50 for controlling the reinjection of the crushed char particles into the combustion chamber 14.

The processing of the char particles to smaller sized particles reduces the characteristic high aerodynamic lift of the larger char particles and reduces the carryover of these reinjection particles from the furnace prior to complete combustion. In addition, the size reducing process also acts as a mechanism to expose additional char surface area which has been encapsulated by incombustible byproducts preventing their complete combustion previously. Collectively, this additional processing of the high carbon content char particles increases combustion efficiency of the system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of treating exhaust from a solid fuel combustion system comprises:
combusting a material in a furnace or boiler;
separating fly ash and char from a flue gas stream;
separating smaller ash particles from larger char particles within the separated fly ash;
reducing a size of the larger char particles ; and
reinjecting the char particles that have been reduced in size into the furnace or boiler for re-burning.

2. The method according to claim 1, wherein reducing a size of the large particles includes one of grinding or crushing the char particles.

3. The method according to claim 1, wherein reinjecting the char particles that have been reduced in size into the combustion chamber includes using a blower to blow the reduced sized char particles into the combustion chamber.

4. The method according to claim 3, wherein the blower mixes atmospheric air or flue gas with the char particles that have been reduced in size.

5. A solid fuel combustion system is provided for combusting fuel, comprising:
a combustion chamber into which the fuel is introduced;
a first separating system separates fly ash and char mixture from a flue gas stream of the combustion chamber;
a second separating system is provided for separating small ash particles from larger char particles;
a reducing device is provided for reducing the size of the larger char particles into smaller particles; and
a re-injecting system for re-injecting the reduced size char particles into the combustion chamber.

6. The solid fuel combustion system according to claim 5, where the reducing device includes one of a crusher or a grinder.

7. The solid fuel combustion system according to claim 5, wherein the re-injecting system includes a blower.

8. The solid fuel combustion system according to claim 7, wherein the blower mixes atmospheric air or flue gas with the reduced size char particles.
